(19) United States
(12) Patent Application Publication
(10) Pub. No.: US 2011/0141160 A1
(43) Pub. Date: Jun. 16, 2011

(54) COMPENSATION TECHNIQUE FOR LUMINANCE DEGRADATION IN ELECTRO-LUMINANCE DEVICES

(75) Inventors: Arokia Nathan, Cambridge (GB); G. Reza Chaji, Waterloo (CA); Shahin Jafarabadiashtiani, Waterloo (CA)

(73) Assignee: Ignis Innovation Inc., Kitchener (CA)

(21) Appl. No.: 12/965,610

(22) Filed: Dec. 10, 2010

Related U.S. Application Data
(63) Continuation of application No. 11/519,338, filed on Sep. 12, 2006.

(30) Foreign Application Priority Data
Sep. 13, 2005 (CA) 2518276

(51) Int. Cl. G09G 5/10; G09G 5/00

(52) U.S. Cl. 345/690; 345/212

(57) ABSTRACT

A method and system for compensation for luminance degradation in electro-luminance devices is provided. The system includes a pixel circuit having a light emitting device, a storage capacitor, a plurality of transistors, and control signal lines to operate the pixel circuit. The storage capacitor is connected or disconnected to the transistor and a signal line(s) when programming and driving the pixel circuit.

### FIELD OF INVENTION

The present invention relates to electro-luminance device displays, and more specifically to a driving technique for the electro-luminance device displays to compensate for luminance degradation.

### BACKGROUND OF THE INVENTION

Electro-luminance displays have been developed for a wide variety of devices, such as cell phones. In particular, active-matrix organic light-emitting diode (AMOLED) displays with amorphous silicon (a-Si), poly-silicon, organic, or other driving backplane have become more attractive due to advantages, such as feasible flexible displays, its low cost fabrication, high resolution, and a wide viewing angle.

An AMOLED display includes an array of rows and columns of pixels, each having an organic light-emitting diode (OLED) and backplane electronics arranged in the array of rows and columns. Since the OLED is a current driven device, the pixel circuit of the AMOLED should be capable of providing an accurate and constant drive current.

There is a need to provide a method and system that is capable of providing constant brightness with high accuracy and reducing the effect of the aging of the pixel circuit.

### SUMMARY OF THE INVENTION

It is an object of the invention to provide a method and system that obviates or mitigates at least one of the disadvantages of existing systems.

In accordance with an aspect of the present invention there is provided a pixel circuit including a light emitting device and a storage capacitor having a first terminal and a second terminal. The pixel circuit includes a first transistor having a gate terminal, a first terminal and a second terminal where the gate terminal is connected to a first select line. The pixel circuit includes a second transistor having a gate terminal, a first terminal and a second terminal where the first terminal is connected to the second terminal of the first transistor, and the second terminal is connected to the light emitting device. The pixel circuit includes a third transistor having a gate terminal, a first terminal and a second terminal where the gate terminal is connected to a second select line, the first terminal is connected to the second terminal of the first transistor, and the second terminal is connected to the gate terminal of the second transistor and the first terminal of the storage capacitor. The pixel circuit includes a fourth transistor having a gate terminal, a first terminal and a second terminal where the gate terminal is connected to a third select line, the first terminal is connected to the second terminal of the storage capacitor, and the second terminal is connected to the second terminal of the second transistor and the light emitting device. The pixel circuit includes a fifth transistor having a gate terminal, a first terminal and a second terminal where the gate terminal is connected to the second select line, the first terminal is connected to a signal line, and the second terminal is connected to the first terminal of the forth transistor and the second terminal of the storage capacitor.

In the above pixel circuit, the third select line may be the first select line.

The above pixel circuit may include a sixth transistor having a gate terminal, a first terminal and a second terminal where the gate terminal is connected to the second select line, the first terminal is connected to the first terminal of the second transistor, and the second terminal is connected to a bias current line.

In accordance with a further of the present invention there is provided a display system including a display array formed by the pixel circuit, and a driving module for programming and driving the pixel circuit.

In accordance with a further of the present invention there is provided a method for compensating for degradation of the light emitting device in the pixel circuit. The method includes the steps of charging the storage capacitor and discharging the storage capacitor. The step of charging the storage capacitor includes connecting the storage capacitor to the signal line. The method includes the step of disconnecting the storage capacitor from the signal line and connecting the second terminal of the storage capacitor to the second terminal of the second transistor.

In accordance with a further of the present invention there is provided a method for compensating for shift in a threshold voltage of the transistor in the pixel circuit. The method includes the steps of charging the storage capacitor and discharging the storage capacitor. The step of charging the storage capacitor includes connecting the storage capacitor to the signal line. The method includes the step of disconnecting the storage capacitor from the signal line and connecting the second terminal of the storage capacitor to the second terminal of the second transistor.

In accordance with a further of the present invention there is provided a method for compensating for ground bouncing or IR drop in the pixel circuit. The method includes the steps of charging the storage capacitor and discharging the storage capacitor. The step of charging the storage capacitor includes connecting the storage capacitor to the signal line and the bias current line. The method includes the step of disconnecting the storage capacitor from the signal line and the bias current line and connecting the second terminal of the storage capacitor to the second terminal of the second transistor.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1A is a diagram illustrating an example of a pixel circuit along with its control signal lines to which a pixel driving scheme in accordance with an embodiment of the present invention is applied;

FIG. 1B is a timing diagram illustrating an example of a method of operating the pixel circuit of FIG. 1A;

FIG. 2 is a graph illustrating a simulation result for FIGS. 1A-1B;

FIG. 3 is a graph illustrating another simulation result for FIGS. 1A-1B;

FIG. 4A is a diagram illustrating an example of a pixel circuit along with its control signal lines to which the pixel driving scheme in accordance with another embodiment of the present invention is applied;

FIG. 4B is a timing diagram illustrating an example of a method of operating the pixel circuit of FIG. 4A;

FIG. 5A is a diagram illustrating an example of a pixel circuit along with its control signal lines to which the pixel driving scheme in accordance with a further embodiment of the present invention is applied;

FIG. 5B is a timing diagram illustrating an example of a method of operating the pixel circuit of FIG. 5A;

FIG. 6 is a diagram illustrating an example of a display system with a display array having the pixel circuit of FIG. 1A;

FIG. 7 is a timing diagram illustrating an example of a method of operating the display array of FIG. 6;

FIG. 8 is a diagram illustrating an example of a display system with a display array having the pixel circuit of FIG. 4A;

FIG. 9 is a timing diagram illustrating an example of a method of operating the display array of FIG. 8;

FIG. 10 is a diagram illustrating an example of a display system with a display array having the pixel circuit of FIG. 5A; and

FIG. 11 is a timing diagram illustrating an example of a method of operating the display array of FIG. 10.

### DETAILED DESCRIPTION

Embodiments of the present invention are described using a pixel circuit having a light emitting device, such as an organic light emitting diode (OLED), and a plurality of transistors. However, the pixel circuit may include any light emitting device other than the OLED. The transistors in the pixel circuit may be n-type transistors, p-type transistors or combinations thereof. The transistors in the pixel circuit may be fabricated using amorphous silicon, nano/micro crystalline silicon, poly silicon, organic semiconductors technologies (e.g. organic TFT), NMOS/PMOS technology or CMOS technology (e.g. MOSFET). A display having the pixel circuit may be a single color, multi-color or a fully color display, and may include one or more than one electroluminescence (EL) element (e.g., organic EL). The display may be an active matrix light emitting display. The display may be used in DVDs, personal digital assistants (PDAs), computer displays, or cellular phones.

In the description, “pixel circuit” and “pixel” may be used interchangeably. In the description below, “signal” and “line” may be used interchangeably. In the description below, “connect (or connected)” and “couple (or coupled)” may be used interchangeably, and may be used to indicate that two or more elements are directly or indirectly in physical or electrical contact with each other.

The embodiments of the present invention involve a driving method of driving the pixel circuit, which includes an in-pixel compensation technique for compensating for at least one of OLED degradation, backplane instability (e.g. TFT threshold shift), and ground bouncing (or IR drop). The driving scheme allows the pixel circuit to provide a stable luminance independent of the shift of the characteristics of pixel elements due to, for example, the pixel aging under prolonged display operation and process variation. This enhances the brightness stability of the OLED and efficiently improves the display operating lifetime.

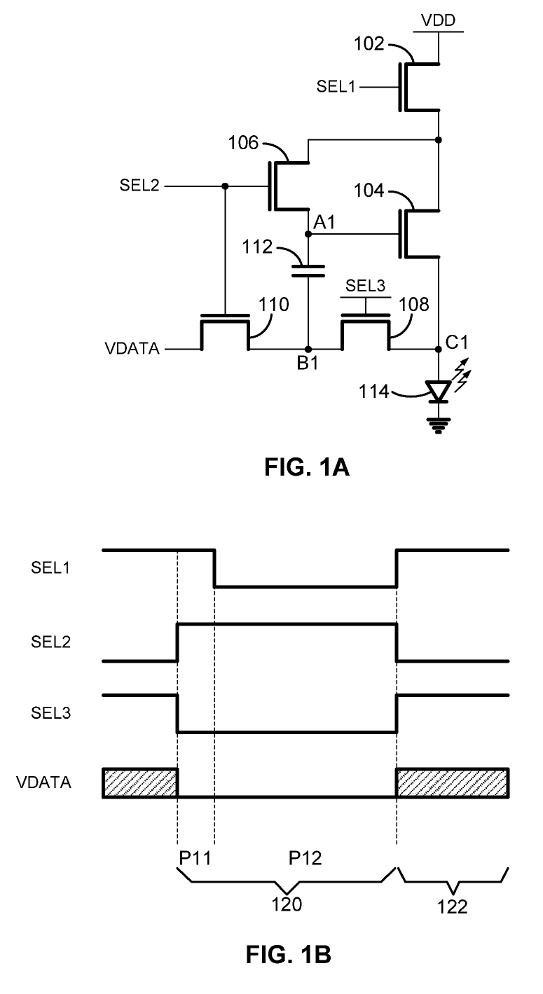

FIG. 1A illustrates an example of a pixel circuit along with its control signal lines to which a pixel driving scheme in accordance with an embodiment of the present invention is applied. The pixel circuit 100 of FIG. 1A includes transistors 102-110, a storage capacitor 112 and an OLED 114. The pixel circuit 100 is connected to three select lines SEL1, SEL2, and SEL3, a signal line VDATA, a voltage line VDD, and a common ground.

The transistors 102-110 may be amorphous silicon, poly silicon, or organic thin-film transistors (TFT) or standard NMOS in CMOS technology. It would be appreciated by one of ordinary skill in the art that the pixel circuit 100 can be rearranged using p-type transistors.

The transistor 104 is a driving transistor. The source and drain terminals of the driving transistor 104 are connected to the anode electrode of the OLED 114 and the source terminal of the transistor 102, respectively. The gate terminal of the driving transistor 104 is connected to the signal line VDATA through the transistor 110 and is connected to the source terminal of the transistor 106. The drain terminal of the transistor 106 is connected to the source terminal of the transistor 102 and its gate terminal is connected to the select line SEL2.

The drain terminal of the transistor 108 is connected to the source terminal of the transistor 110, its source terminal is connected to the anode of the OLED 114, and its gate terminal is connected to the select line SEL3.

The drain terminal of the transistor 110 is connected to the signal line VDATA, and its gate terminal is connected to the select line SEL2.

The driving transistor 104, the transistor 106 and the storage capacitor 112 are connected at node A1. The transistors 108 and 110 and the storage capacitor 112 are connected at node B1.

FIG. 1B illustrates an example of a method of operating the pixel circuit 100 of FIG. 1A. The pixel circuit 100 of FIG. 1A includes n-type transistors. However, it would be understood by one of ordinary skill in the art that the method of FIG. 1B is applicable to a pixel circuit having p-type transistors.

Referring to FIGS. 1A-1B, the operation of the pixel circuit 100 includes two operating cycles: programming cycle 120 and driving cycle 122. At the end of the programming cycle 120, node A1 is charged to (V_{P}+V_{T}+ΔV_{OLED}) where V_{P} is a programming voltage, V_{T} is the threshold voltage of the transistor 104, and ΔV_{OLED} is the OLED voltage shift under bias stress.

The programming cycle 120 includes two sub-cycles: pre-charging P11 and compensation P12, hereinafter referred to as pre-charging sub-cycle P11 and compensation sub-cycle P12, respectively.

During the pre-charging sub-cycle P11, the select lines SEL1 and SEL2 are high and SEL3 is low, resulting in turning the transistors 102, 106 and 110 on, and the transistor 108 off respectively. The voltage at VDATA is set to (V_{OLEDi}−V_{P}). “V_{P}” is a programming voltage. “i” represents initial voltage of OLED. “V_{OLEDi}” is a constant voltage and can be set to the initial ON voltage of the OLED 114. However, V_{OLEDi} can be set to other voltages such as zero. At the end of the pre-charging sub-cycle P11, the storage capacitor 112 is charged with a voltage close to (VDD+V_{P}−V_{OLEDi}).

During the compensation sub-cycle P12, the select line SEL2 is high so that the transistors 106 and 110 are on, and the select lines SEL1 and SEL3 are low so that the transistors 102 and 108 are off. As a result, the storage capacitor 112 starts discharging through the transistor 104 and the OLED 114 until the current through the driving transistor 104 and the OLED 114 becomes close to zero. Consequently, the voltage close to (V_{T}+V_{P}+V_{OLED}−V_{OLEDi}) is stored in the storage capacitor 112 where V_{OLED} is the ON voltage of the OLED 114.

During the driving cycle 122, the select line SEL2 is low so that the transistors 106 and 110 are off, and the select lines SEL1 and SEL3 are high so that the transistors 102 and 108 are on. As a result, the storage capacitor 112 is disconnected from the signal line VDATA and is connected to the source of the driving transistor 104.

If the driving transistor 104 is in saturation region, a current close to K(V_{P}+ΔV_{OLED})² goes through the OLED 114 until the next programming cycle where K is the trans-conductance coefficient of the driving transistor 104, and ΔV_{OLED}=V_{OLED}−V_{OLEDi}.

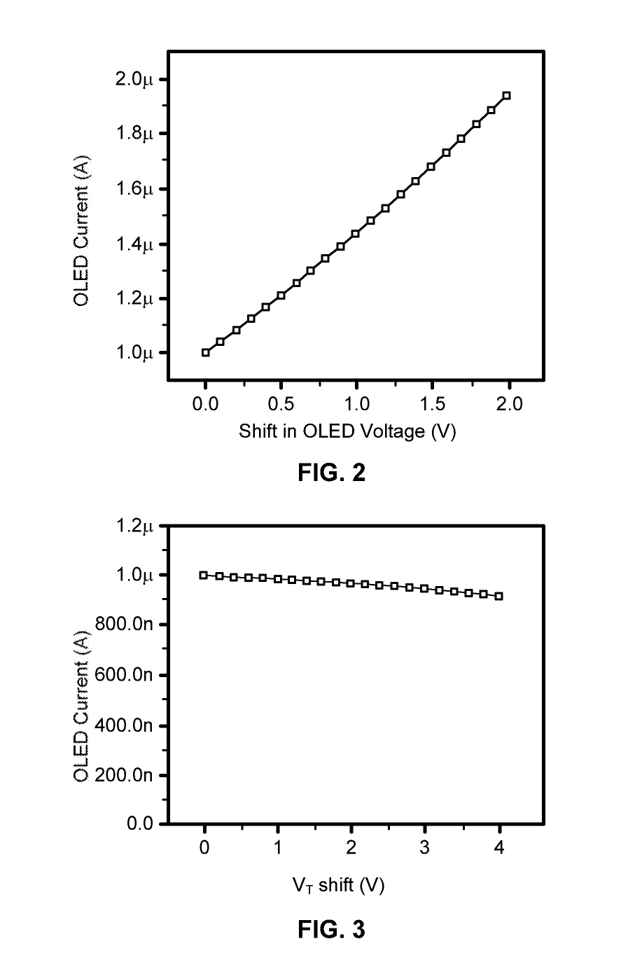

FIG. 2 illustrates an example of a simulation result for the operation of FIGS. 1A-1B. The graph of FIG. 2 represents OLED current during the driving cycle 122 as a function of shift in its voltage. Referring to FIGS. 1A, 1B and 2, it can be seen that as ΔV_{OLED} increases over time, the driving current of the OLED 114 is also increased. Thus, the pixel circuit 100 compensates for luminance degradation of the OLED 114 by increasing the driving current of the OLED 114.

FIG. 3 illustrates an example of another simulation result for the operation of FIGS. 1A-1B. The graph of FIG. 3 represents OLED current during the driving cycle 122 as a function of shift in the threshold voltage of the driving transistor 104. Referring to FIGS. 1A, 1B and 3, the pixel circuit 100 compensates for shift in the threshold voltage of the driving transistor 104 since the driving current of the OLED 114 is independent of the threshold of the driving transistor 104. The result as shown in FIG. 3 emphasizes the OLED current stability for 4-V shift in the threshold of the driving transistor.

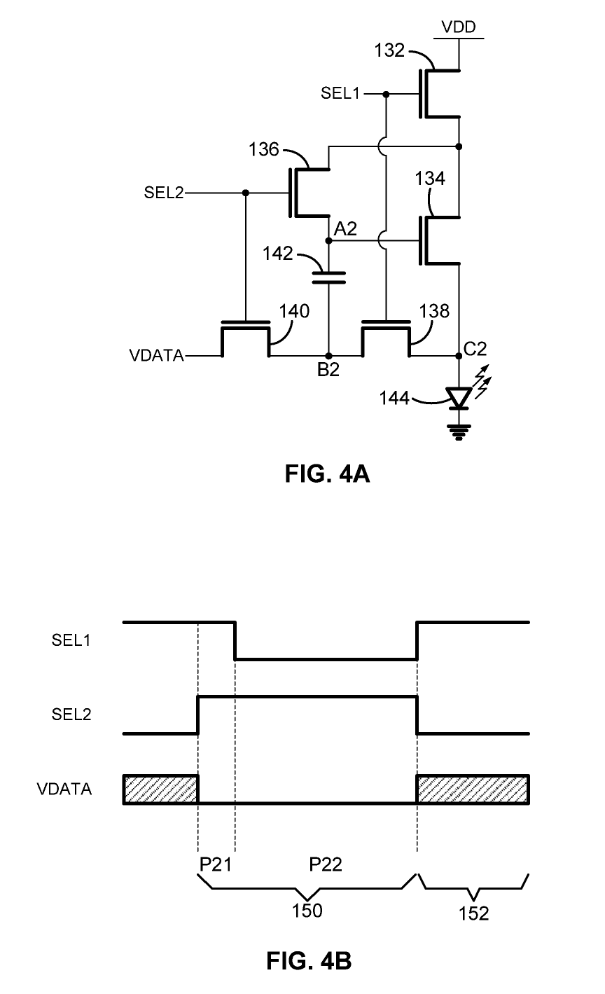

FIG. 4A illustrates an example of a pixel circuit along with its control signal lines to which the pixel driving scheme in accordance with another embodiment of the present invention is applied. The pixel circuit 130 of FIG. 4A includes five transistors 132-140, a storage capacitor 142 and an OLED 144. The pixel circuit 130 is connected to two select lines SEL1 and SEL2, a signal line VDATA, a voltage line VDD, and a common ground.

The transistors 132-140 may be same or similar to the transistors 102-110 of FIG. 1A. The transistors 132-140 may be amorphous silicon, poly silicon, or organic TFT or standard NMOS in CMOS technology. The storage capacitor 142 and the OLED 140 are same or similar to the storage capacitor 112 and the OLED 114 of FIG. 1A, respectively.

The transistor 134 is a driving transistor. The source and drain terminals of the driving transistor 134 are connected to the anode electrode of the OLED 144 and the source of the transistor 132, respectively. The gate terminal of the driving transistor 134 is connected to the signal line VDATA through the transistor 140, and is connected to the source terminal of the transistor 136. The drain terminal of the transistor 136 is connected to the source terminal of the transistor 132 and its gate terminal is connected to the select line SEL2.

The drain terminal of the transistor 138 is connected to the source terminal of the transistor 140, its source terminal is connected to the anode of the OLED 144, and its gate terminal is connected to the select line SEL1.

The drain terminal of the transistor 140 is connected to the signal line VDATA, and its gate terminal is connected to the select line SEL2.

The driving transistor 134, the transistor 136 and the storage capacitor 142 are connected at node A2. The transistors 138 and 140 and the storage capacitor 142 are connected at node B2.

FIG. 4B illustrates an example of a method of operating the pixel circuit 130 of FIG. 4A. The pixel circuit 130 of FIG. 4A includes n-type transistors. However, it would be understood by one of ordinary skill in the art that the method of FIG. 4B is applicable to a pixel circuit having p-type transistors.

Referring to FIGS. 4A-4B, the operation of the pixel circuit 130 includes two operating cycles: programming cycle 150 and driving cycle 152. At the end of the programming cycle 150, node A2 is charged to (V_{P}+V_{T}+ΔV_{OLED}) where V_{P} is a programming voltage, V_{T} is the threshold voltage of the transistor 134, and ΔV_{OLED} is the OLED voltage shift under bias stress.

The programming cycle 150 includes two sub-cycles: pre-charging P21 and compensation P22, hereinafter referred to as pre-charging sub-cycle P21 and compensation sub-cycle P22, respectively.

During the pre-charging sub-cycle P21, the select lines SEL1 and SEL2 are high, and VDATA goes to a proper voltage V_{OLEDi} that turns off the OLED 144. V_{OLEDi} is a predefined voltage which is less than minimum ON voltage of the OLEDs. At the end of the pre-charging sub-cycle P21, the storage capacitor 142 is charged with a voltage close to (VDD+V_{OLEDi}). The voltage at VDATA is set to (V_{OLEDi}−V_{P}) where V_{P} is a programming voltage.

During the compensation sub-cycle P22, the select line SEL2 is high so that the transistors 136 and 140 are on, and the select line SEL1 is low so that the transistors 132 and 138 are off. The voltage of VDATA at P22 is different from that of P21 to properly charge A2 to (V_{P}+V_{T}+ΔV_{OLED}) at the end of P22. As a result, the storage capacitor 142 starts discharging through the driving transistor 134 and the OLED 144 until the current through the driving transistor 134 and the OLED 144 becomes close to zero. Consequently, the voltage close to (V_{T}+V_{P}+V_{OLED}−V_{OLEDi}) is stored in the storage capacitor 142 where V_{OLED} is the ON voltage of the OLED 144.

During the driving cycle 152, the select SEL2 is low, resulting in turning the transistors 136 and 140 off. The select line SEL1 is high, resulting in turning the transistors 132 and 138 on. As a result, the storage capacitor 142 is disconnected from the signal line VDATA and is connected to the source terminal of the driving transistor 134

If the driving transistor 134 is in saturation region, a current close to K(V_{P}+ΔV_{OLED})² goes through the OLED 144 until the next programming cycle where K is the trans-conductance coefficient of the driving transistor 134, and ΔV_{OLED}=V_{OLED}−V_{OLEDi}. As a result, the driving current of the OLED 144 increases, as the AVOLED increases over time. Thus, the pixel circuit 130 compensates for luminance degradation of the OLED 144 by increasing the driving current of the OLED 144.

Moreover, the pixel circuit 130 compensates for shift in threshold voltage of the driving transistor 134 and so the driving current of the OLED 144 is independent of the threshold V_{T}.

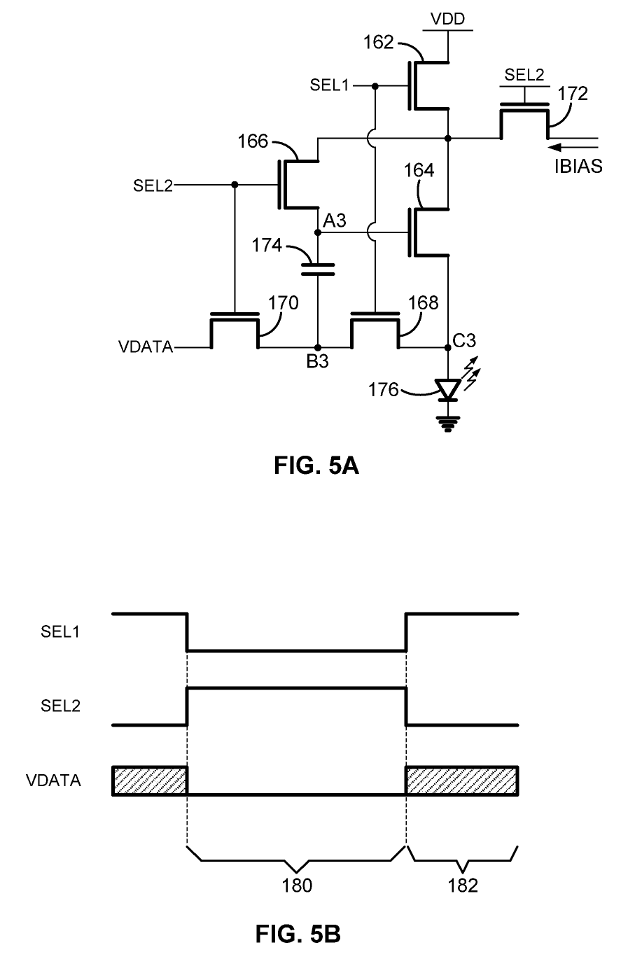

FIG. 5A illustrates an example of a pixel circuit along with its control signal lines to which the pixel driving scheme in accordance with a further embodiment of the present invention is applied. The pixel circuit 160 of FIG. 5A includes six transistors 162-172, a storage capacitor 174 and an OLED 176. The pixel circuit 160 is connected to two select lines SEL1 and SEL2, a signal line VDATA, a voltage line VDD, a bias current line IBIAS, and a common ground.

The transistors 162-172 may be amorphous silicon, poly silicon, or organic TFT or standard NMOS in CMOS technology. The storage capacitor 174 and the OLED 176 are same or similar to the storage capacitor 112 and the OLED 114 of FIG. 1A, respectively.

The transistor 164 is a driving transistor. The source and drain terminals of the driving transistor 164 are connected to the anode electrode of the OLED 176 and the source terminal of the transistor 162, respectively. The gate terminal of the driving transistor 164 is connected to the signal line VDATA through the transistor 170 and is connected to the source terminal of the transistor 166. The drain terminal of the transistor 166 is connected to the source terminal of the transistor 162 and its gate terminal is connected to the select line SEL2.

The drain terminal of the transistor 168 is connected to the source terminal of the transistor 170, its source terminal is connected to the anode of the OLED 176, and its gate terminal is connected to the select line SEL1.

The drain terminal of the transistor 170 is connected to VDATA, and its gate terminal is connected to the select line SEL2.

The drain terminal of the transistor 172 is connected to the bias line IBIAS, its gate terminal is connected to the select line SEL2, and its source terminal is connected to the source terminal of the transistor 162 and the drain terminal of the transistor 164.

The driving transistor 164, the transistor 166 and the storage capacitor 174 are connected at node A3. The transistors 168 and 170 and the storage capacitor 174 are connected at node B3.

FIG. 5B illustrates an example of a method of operating the pixel circuit 160 of FIG. 5A. The pixel circuit 160 of FIG. 5A includes n-type transistors. However, it would be understood by one of ordinary skill in the art that the method of FIG. 5B is applicable to a pixel circuit having p-type transistors.

Referring to FIGS. 5A-5B, the operation of the pixel circuit 160 includes two operating cycles: programming cycle 180 and driving cycle 182. At the beginning of the second operating cycle 182, node A3 is charged to (V_{P}+V_{T}+ΔV_{OLED}) where V_{P} is a programming voltage, V_{T} is the threshold voltage of the transistor 164, and ΔV_{OLED} is the OLED voltage shift under bias stress. V_{T} and ΔV_{OLED} are generated by large IBIAS resulting in a fast programming.

During the first operating cycle 180, the select line SEL1 is low, the select line SEL2 is high, and VDATA goes to a proper voltage (V_{OLEDi}−V_{P}) where V_{P} is a programming voltage. This proper voltage is a predefined voltage which is less than minimum ON voltage of the OLEDs. Also, the bias line IBIAS provides bias current (referred to as I_{BIAS}) to the pixel circuit 160. At the end of this cycle node A3 is charged to V_{BIAS}+V_{T}+V_{OLED}(I_{BIAs9}) where V_{BIAS} is related to the bias current I_{BIAS}, and V_{OLED}(I_{BIAS}) is the OLED 176 voltage corresponding to I_{BIAS}. Voltage at node A3 is independent of V_{P} at the end of 180. Charging to (V_{P}+V_{T}+ΔV_{OLED}) happens at the beginning of 182.

During the second operating cycle 182, the select line SEL1 is high and the select line SEL2 is low. As a result node B3 is charged to V_{OLED}(I_{P}) where V_{OLED}(I_{P}) is the OLED 176 voltage corresponding to the pixel current. Thus, the gate-source voltage of the transistor 164 becomes (V_{P}+ΔV_{OLED}+V_{T}) where ΔV_{OLED}=V_{OLEd}(I_{BIAS})−V_{OLEDi}. Since the OLED voltage increases for a constant luminance while its luminance decreases, the gate-source voltage of the transistor 164 increases resulting in higher OLED current. Consequently, the OLED 176 luminance remains constant.

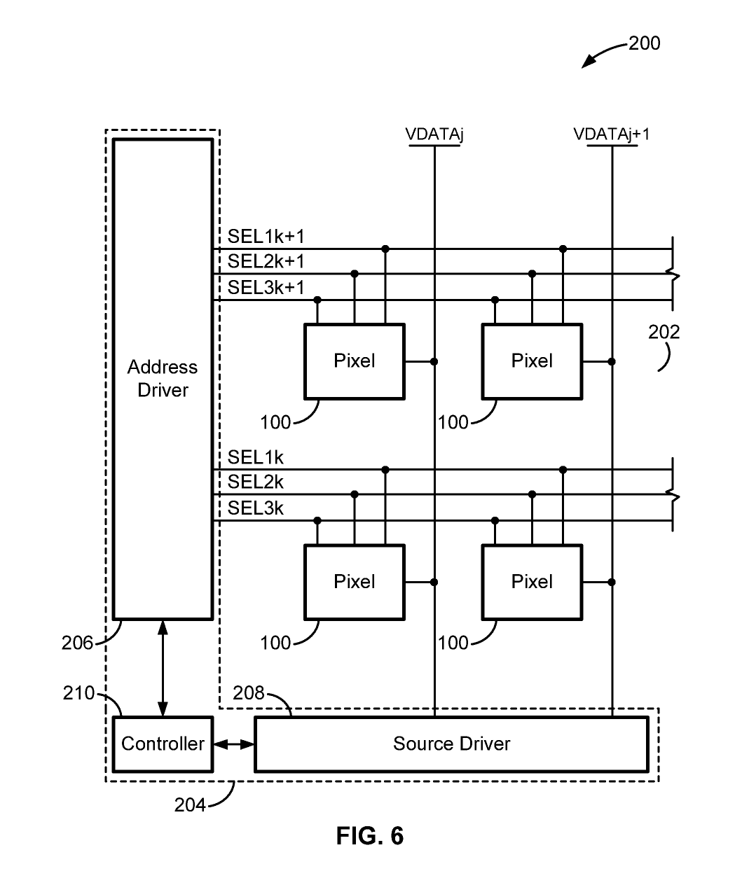

FIG. 6 illustrates an example of a display system 200 including the pixel circuit 100 of FIG. 1A. The display array 202 of FIG. 6 includes a plurality of pixel circuit 100 arranged in rows and columns, and may form an active matrix organic light emitting diode (AMOLED) display. VDATAj (j=1, 2, . . . ) corresponds to VDATA of FIG. 1A. SEL1k, SEL2k and SEL3k (k=1, 2, . . . ) correspond to SEL1, SEL2 and SEL3 of FIG. 1A, respectively. The select lines SEL1k, SEL2k and SEL3k are shared among the pixels in the common row of the display array 202. The signal line VDATAj is shared among the pixels in the common column of the display array 202.

The display system 200 includes a driving module 204 having an address driver 206, a source driver 208, and a controller 210. The select lines SEL1k, SEL2k and SEL3k are driven by the address driver 206. The signal line VDATAj is driven by the source driver 208. The controller 210 controls the operation of the address driver 206 and the source driver 208 to operate the display array 202.

The waveforms shown in FIG. 1B are generated by the driving module 204. The driver module 204 also generate the programming voltage. The compensation for OLED degradation, threshold voltage shift and ground bouncing occur in pixel. During the third cycle (122 of FIG. 1B), the gate-source voltage of the driving transistor is defined by the voltage stored in the storage capacitor (112 of FIG. 1). Therefore, the ground bouncing does not change the gate-source voltage and so the pixel current become stable.

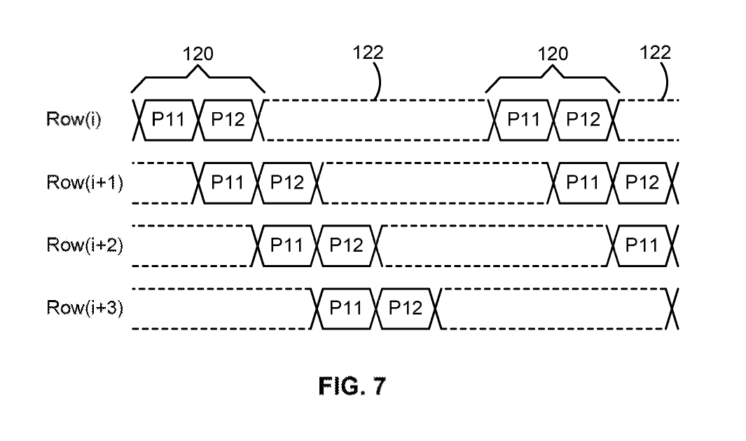

FIG. 7 illustrates an example of a method of operating the display array of FIG. 6. an example of In FIG. 7, Row(i) (i=1, 2, . . . ) represents a row of the display array 202 of FIG. 6. “120” and “122” in FIG. 7 represent “programming cycle” and “driving cycle” and correspond to those of FIG. 1B, respectively. “P11” and “P12” in FIG. 7 represent “pre-charging sub-cycle” and “compensation sub-cycle” and correspond to those of FIG. 1B, respectively. The compensation sub-cycle P11 in a row and the pre-charging sub-cycle P12 in an adjacent row are performed in parallel. Further, during the driving cycle 122 in a row, the compensation sub-cycle P22 is performed in an adjacent row. The display system 200 of FIG. 6 is designed to implement the parallel operation, i.e., having capability of carrying out different cycles independently without affecting each other.

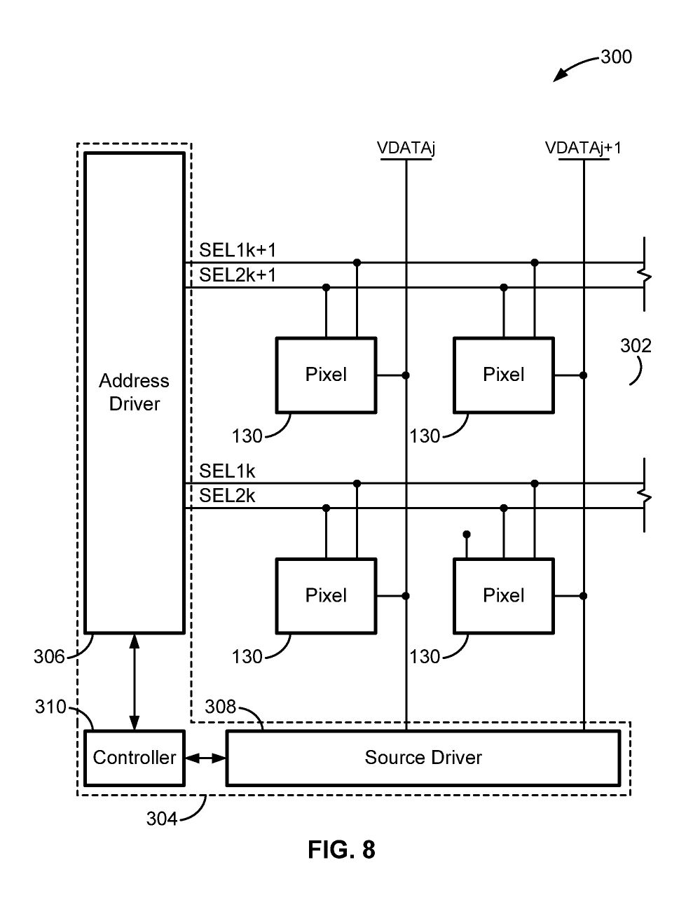

FIG. 8 illustrates an example of a display system 300 including the pixel circuit 130 of FIG. 4A. The display array 302 of FIG. 8 includes a plurality of pixel circuit 130 arranged in rows and columns, and may form an AMOLED display. VDATAj (j=1, 2, . . . ) corresponds to VDATA of FIG. 4A. SEL1k and SEL2k (k=1, 2, . . . ) correspond to SEL1 and SEL2 of FIG. 4A, respectively. The select lines SEL1k and SEL2k are shared among the pixels in the common row of the display array 302. The signal line VDATAj is shared among the pixels in the common column of the display array 302.

The display system 300 includes a driving module 304 having an address driver 306, a source driver 308, and a controller 310. The select lines SEL1k and SEL2k are driven by the address driver 306. The signal line VDATAj is driven by the source driver 308. The controller 310 controls the operation of the address driver 306 and the source driver 308 to operate the display array 302.

The waveforms shown in FIG. 4B are generated by the driving module 304. The driver module 304 also generates the programming voltage. The compensation for OLED degradation, threshold voltage shift and ground bouncing occur in pixel. During the third cycle (152 of FIG. 4B), the gate-source voltage of the driving transistor is defined by the voltage stored in the storage capacitor (142 of FIG. 4A). Therefore, the ground bouncing does not change the gate-source voltage and so the pixel current become stable.

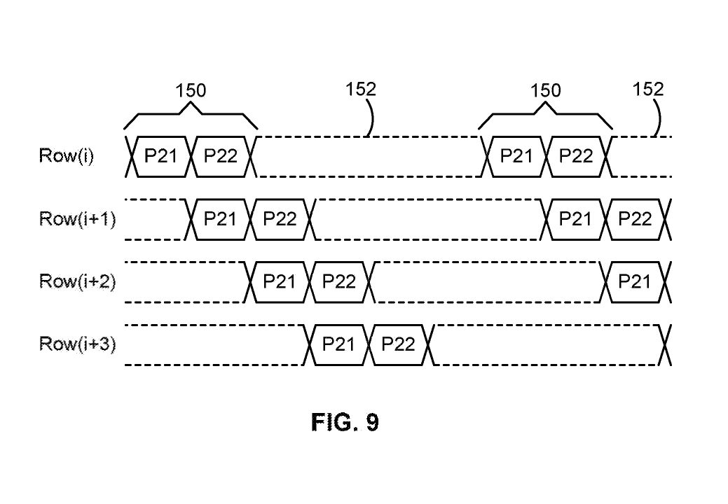

FIG. 9 illustrates an example of a method of operating the display array of FIG. 8. an example of In FIG. 9, Row(i) (i=1, 2, . . . ) represents a row of the display array 302 of FIG. 8. “150” and “152” in FIG. 9 represent “programming cycle” and “driving cycle” and correspond to those of FIG. 4B, respectively. “P21” and “P22” in FIG. 9 represent “pre-charging sub-cycle” and “compensation sub-cycle” and correspond to those of FIG. 4B, respectively. The compensation sub-cycle P21 in a row and the pre-charging sub-cycle P22 in an adjacent row are performed in parallel. Further, during the driving cycle 152 in a row, the compensation sub-cycle P22 is performed in an adjacent row. The display system 300 of FIG. 8 is designed to implement the parallel operation, i.e., having capability of carrying out different cycles independently without affecting each other.

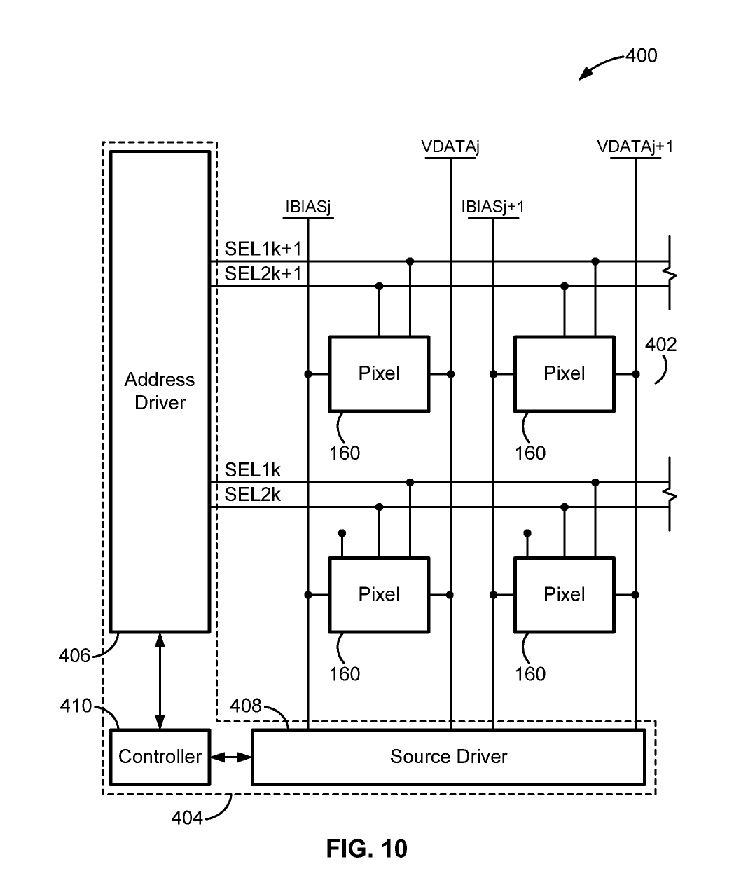

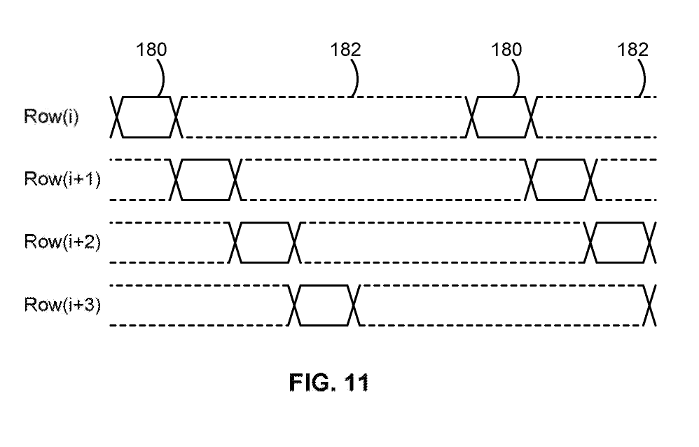

FIG. 10 illustrates an example of a display system 400 including the pixel circuit 160 of FIG. 5A. The display array 402 of FIG. 10 includes a plurality of pixel circuit 160 arranged in rows and columns, and is an AMOLED display. The display array 402 may be an AMOLED display. VDATAj (j=1, 2, . . . ) corresponds to VDATA of FIG. 4A. IBIASj (j=1, 2, . . . ) corresponds to IBIAS of FIG. 4A. SEL1k and SEL2k (k=1, 2, . . . ) correspond to SEL1 and SEL2 of FIG. 4A, respectively. The select lines SEL1k and SEL2k are shared among the pixels in the common row of the display array 402. The signal line VDATAj and the bias line IBIASj are shared among the pixels in the common column of the display array 402.

The display system 400 includes a driving module 404 having an address driver 406, a source driver 408, and a controller 410. The select lines SEL1k and SEL2k are driven by the address driver 406. The signal line VDATAj and the bias line IBIASj are driven by the source driver 408. The controller 410 controls the operation of the address driver 406 and the source driver 408 to operate the display array 402.

The waveforms shown in FIG. 5B are generated by the driving module 404. The driver module 404 also generate the programming voltage. The compensation for OLED degradation, threshold voltage shift and ground bouncing occur in pixel. During the second cycle 182 of FIG. 5B, the gate-source voltage of the driving transistor is defined by the voltage stored in the storage capacitor (174 of FIG. 5A). Therefore, the ground bouncing does not change the gate-source voltage and so the pixel current become stable.

FIG. 11 illustrates an example of a method of operating the display array of FIG. 10. an example of In FIG. 9, Row(i) (i=1, 2, . . . ) represents a row of the display array 402 of FIG. 10. “180” and “182” in FIG. 11 correspond to those of FIG. 5B, respectively. For the rows of the display array 402, the programming cycle 180 is subsequently performed. During the driving cycle 182 in a row, the programming cycle 180 is performed in an adjacent row. The display system 400 of FIG. 10 is designed to implement the parallel operation, i.e., having capability of carrying out different cycles independently without affecting each other.

All citations are hereby incorporated by reference.

The present invention has been described with regard to one or more embodiments. However, it will be apparent to persons skilled in the art that a number of variations and modifications can be made without departing from the scope of the invention as defined in the claims.

1-40. (canceled)

41. A pixel circuit comprising:
a light emitting device;
a storage capacitor having a first terminal and a second terminal;
a driving transistor having a gate terminal, a first terminal, and a second terminal, the gate terminal being connected to the second terminal of the storage capacitor; and
a first transistor having a gate terminal, a first terminal, and a second terminal, the gate terminal being connected to a first select line, the first terminal being connected to the first terminal of the storage capacitor, and the second terminal being connected to the light emitting device and the first terminal of the driving transistor.

42. The pixel circuit of claim 41, further comprising:
a second transistor having a gate terminal, a first terminal, and a second terminal, the gate terminal being connected to a second select line, the first terminal being connected to the second terminal of the storage capacitor, the second terminal being connected to the second terminal of the driving transistor.

43. The pixel circuit of claim 41, wherein the storage capacitor is configured to be charged during a pre-charging cycle with an initial voltage exceeding a compensated voltage, the compensated voltage being substantially equal to the sum of a programming voltage, a threshold voltage of the driving transistor, and a voltage drop of the light emitting device.

44. The pixel circuit of claim 43, wherein the storage capacitor is configured to partially discharge the initial voltage until the storage capacitor is charged with the compensated voltage.

45. The pixel circuit of claim 43, wherein the compensated voltage is stored on the storage capacitor at the conclusion of the pre-charging cycle, and wherein the pre-charging cycle precedes a driving cycle of the pixel circuit.

46. The pixel circuit of claim 41, wherein the light emitting device is configured to emit light responsive to a driving current flowing through the light emitting device, and wherein the driving current flowing through the light emitting device is controlled responsive to a gate voltage applied to the gate terminal of the driving transistor.

47. The pixel circuit of claim 46, wherein the pixel circuit is configured to compensate for luminance degradation of the light emitting device by increasing the driving current of the light emitting device according to a compensated voltage on the second terminal of the storage capacitor, which sets the gate voltage.

48. The pixel circuit of claim 46, wherein the pixel circuit is configured to compensate for a shift in a threshold voltage of the driving transistor, because the driving current is independent of the threshold voltage of the driving transistor.

49. The pixel circuit of claim 42, wherein the light emitting device is configured to emit light responsive to a driving current flowing through the light emitting device, and wherein the driving current flowing through the light emitting device is controlled responsive to a gate voltage applied to the gate terminal of the driving transistor.

50. The pixel circuit of claim 49, wherein the pixel circuit is configured to compensate for luminance degradation of the light emitting device by increasing the driving current of the light emitting device according to a compensated voltage on the second terminal of the storage capacitor, which sets the gate voltage.

51. The pixel circuit of claim 49, wherein the pixel circuit is configured to compensate for a shift in a threshold voltage of the driving transistor, because the driving current is independent of the threshold voltage of the driving transistor.

52. The pixel circuit of claim 41, wherein the light emitting device is an organic light emitting diode.

53. The pixel circuit of claim 41, wherein the pixel circuit is incorporated in an active matrix organic light emitting diode display.

54. A method of operating a pixel circuit to compensate for shifts in a threshold voltage of a driving transistor and to compensate for shifts in a voltage drop of a light emitting device, wherein the pixel circuit includes:
a light emitting device;
a storage capacitor having a first terminal and a second terminal;
a driving transistor having a gate terminal, a first terminal, and a second terminal, the gate terminal being connected to the second terminal of the storage capacitor;
a first transistor having a gate terminal, a first terminal, and a second terminal, the gate terminal being connected to a first select line, the first terminal being connected to the first terminal of the storage capacitor, and the second terminal being connected to the light emitting device and the first terminal of the driving transistor; and
a second transistor having a gate terminal, a first terminal, and a second terminal, the gate terminal being connected to a second select line, the first terminal being connected to the second terminal of the storage capacitor, the second terminal being connected to the second terminal of the driving transistor;
wherein the method of operating a pixel circuit comprises:
setting the first select line to a voltage below a threshold voltage of the first transistor for disconnecting the first terminal of the storage capacitor from the light emitting device;
setting the second select line to a voltage above a threshold voltage of the second transistor for connecting the second terminal of the storage capacitor to the second terminal of the driving transistor;
applying a pre-charging voltage to the first terminal of the storage capacitor for charging the storage capacitor;
connecting a first voltage supply to the second terminal of the driving transistor for charging the storage capacitor and applying a bias voltage to the gate terminal of the driving transistor;
allowing the storage capacitor to partially discharge through the driving transistor and the light emitting device for compensating for shifts in the threshold voltage of the driving transistor and shifts in the voltage drop of the light emitting device;
setting the second select line to a voltage below the threshold voltage of the second transistor for disconnecting the second terminal of the storage capacitor from the second terminal of the driving transistor;
setting the first select line to a voltage above the threshold voltage of the first transistor for connecting the first terminal of the storage capacitor to the light emitting device;
connecting a second voltage supply to the second terminal of the driving transistor for sending a driving current through the light emitting device.

55. The method of claim 54, wherein the allowing is carried out by discharging the storage capacitor until the storage capacitor is charged with a compensated voltage substantially equal to the sum of the threshold voltage of the driving capacitor, the voltage drop of the light emitting device, and the pre-charging voltage.

56. The method of claim 54, wherein responsive to the setting the first select line to a voltage above the threshold voltage of the first transistor, the first terminal of the storage capacitor has a voltage equal to the voltage drop of the transistor, and the second terminal of the storage capacitor has a compensated voltage substantially equal to the sum of the threshold voltage of the driving capacitor, the voltage drop of the light emitting device, and the pre-charging voltage.

57. The method of claim 54, wherein the pre-charging voltage is a negative programming voltage.

58. The method of claim 54, further comprising:
disconnecting the first voltage supply from the second terminal of the driving transistor.

59. The method of claim 58, wherein the first voltage supply is the second voltage supply.

60. The method of claim 56, wherein the driving current is sent through the light emitting device according to the compensation voltage on the second terminal of the storage capacitor.
